(19) United States
(12) Patent Application Publication
(10) Pub. No.: US 2016/0050237 A1
(43) Pub. Date: Feb. 18, 2016

(54) METHOD AND DEVICE FOR ACQUIRING MULTIMEDIA DATA STREAM

(71) Applicant: Xiaomi Inc., Beijing (CN)

(72) Inventors: Feiyun LI, Beijing (CN); Ziguang GAO, Beijing (CN); Hao CHEN, Beijing (CN)

(73) Assignee: Xiaomi Inc.

(21) Appl. No.: 14/809,466

(22) Filed: Jul. 27, 2015

Related U.S. Application Data
(63) Continuation of application No. PCT/CN2015/071881, filed on Jan. 30, 2015.

(30) Foreign Application Priority Data
Aug. 15, 2014 (CN) 201410403536.8

(51) Int. Cl. H04L 29/06

(52) U.S. Cl. CPC H04L 65/1069; H04L 65/60; H04L 65/4069

(57) ABSTRACT

A method for acquiring a multimedia data stream includes establishing, by a terminal, a socket connection with a target camera device when a preset trigger event is triggered in the terminal and sending a transfer command to the target camera device through the socket connection when an event of starting preview is detected. The transfer command instructs the target camera to transfer the multimedia data stream. The method further includes receiving the multimedia data stream transferred by the target camera device and displaying the multimedia data stream in a specified preview interface.

### CROSS-REFERENCE TO RELATED APPLICATIONS

This application is a Continuation Application of International Application No. PCT/CN2015/071881, filed Jan. 30, 2015, which is based upon and claims priority to Chinese Patent Application No. CN201410403536.8, filed Aug. 15, 2014, the entire contents of both of which are incorporated herein by reference.

### TECHNICAL FIELD

The present disclosure relates to terminal technology and, more particularly, to a method and device for acquiring a multimedia data stream.

### BACKGROUND

With the development of terminal technology and communication technology, camera devices with Wi-Fi (Wireless-Fidelity) have become popular. A terminal can remotely control such a camera device at another place over network, to preview a multimedia data stream taken by the camera device.

However, each time the terminal intends to control the camera device to start a preview operation, the terminal needs to establish a Socket connection (Socket) between the terminal and the camera device. After that, the terminal sends a command to transfer the multimedia data stream to the camera device through the Socket connection, and then receives and previews the multimedia data stream taken by the camera device. When the terminal receives an operation to pause the preview, the Socket connection between the terminal and the camera device is disconnected.

### SUMMARY

In accordance with the present disclosure, there is provided a method for acquiring a multimedia data stream. The method includes establishing, by a terminal, a socket connection with a target camera device when a preset trigger event is triggered in the terminal and sending a transfer command to the target camera device through the socket connection when an event of starting preview is detected. The transfer command instructs the target camera to transfer the multimedia data stream. The method further includes receiving the multimedia data stream transferred by the target camera device and displaying the multimedia data stream in a specified preview interface.

In accordance with the present disclosure, there is also provided a device for acquiring a multimedia data stream. The device includes a processor and a non-transitory computer-readable storage medium storing instructions. The instructions, when executed by the processor, cause the processor to establish a socket connection with a target camera device when a preset trigger event is triggered and send a transfer command to the target camera device through the socket connection when an event of starting preview is detected. The transfer command instructs the target camera to transfer the multimedia data stream. The instructions further cause the processor to receive the multimedia data stream transferred by the target camera device and display the multimedia data stream in a specified preview interface.

In accordance with the present disclosure, there is also provided a non-transitory computer-readable storage medium storing instructions. The instructions, when executed by a processor of a terminal, cause the terminal to establish a socket connection with a target camera device when a preset trigger event is triggered and send a transfer command to the target camera device through the socket connection when an event of starting preview is detected. The transfer command instructs the target camera to transfer a multimedia data stream. The instructions further cause the processor to receive the multimedia data stream transferred by the target camera device and display the multimedia data stream in a specified preview interface.

It should be understood that the above general description and the detailed description below are merely exemplary, and do not limit the present disclosure.

### BRIEF DESCRIPTION OF THE DRAWINGS

The accompanying drawings, which are hereby incorporated in and constitute a part of this specification, illustrate embodiments of the invention, and explain the principles of the invention together with the description.

FIG. 1 is a flowchart of a method for acquiring a multimedia data stream according to an exemplary embodiment of the present disclosure.

FIG. 2A is a flowchart of a method for acquiring a multimedia data stream according to another exemplary embodiment of the present disclosure.

FIG. 2B shows an example of executing 201 in FIG. 2A according to an exemplary embodiment of the present disclosure.

FIG. 3 is a flowchart of a method for starting a target camera device according to an exemplary embodiment of the present disclosure.

FIG. 4 is a flowchart of a method for starting the target camera device according to another exemplary embodiment of the present disclosure.

FIG. 5 is a flowchart of a method for acquiring a multimedia data stream according to a further exemplary embodiment of the present disclosure.

FIG. 6 is a diagram showing an interface containing a list of smart devices according to an exemplary embodiment of the present disclosure.

FIG. 7 is a diagram showing a preview interface according to an exemplary embodiment of the present disclosure.

FIG. 8 is a block diagram of a device for acquiring a multimedia data stream according to an exemplary embodiment of the present disclosure.

FIG. 9 is a block diagram of a device for acquiring a multimedia data stream according to another exemplary embodiment of the present disclosure.

### DESCRIPTION OF THE EMBODIMENTS

The features and advantages of the disclosure may become more clear, through a further detailed description given hereinafter to embodiments of the disclosure in conjunction with the accompany drawings. It is noted that in the flowcharts shown in the drawings, the order of the processes shown in the flowcharts does not necessarily reflect the order in which these processes are performed according to the present disclosure. Methods consistent with embodiments of the present disclosure can be implemented in a terminal.

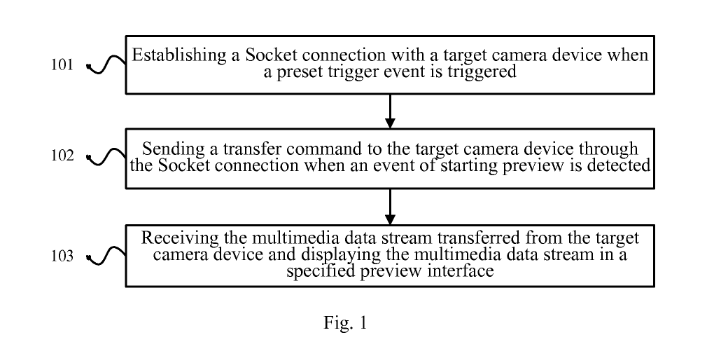

FIG. 1 is a flowchart showing an exemplary method for acquiring a multimedia data stream consistent with the present disclosure. As illustrated in FIG. 1, at 101, a Socket connection with a target camera device is established when a preset trigger event is triggered. At 102, a command to transfer the multimedia data stream (hereinafter also referred to as a “transfer command”) to the target camera device through the Socket connection is sent when an event of starting preview is detected. At 103, the multimedia data stream transferred from the target camera device is received and is displayed in a specified preview interface.

In some embodiments, if the terminal and the target camera are in different networks, Network Address Translation (NAT) traversal may be needed to establish the Socket connection. NAT traversal techniques address the problem in a TCP/IP related network of establishing a connection between hosts in private TCP/IP networks using NAT devices.

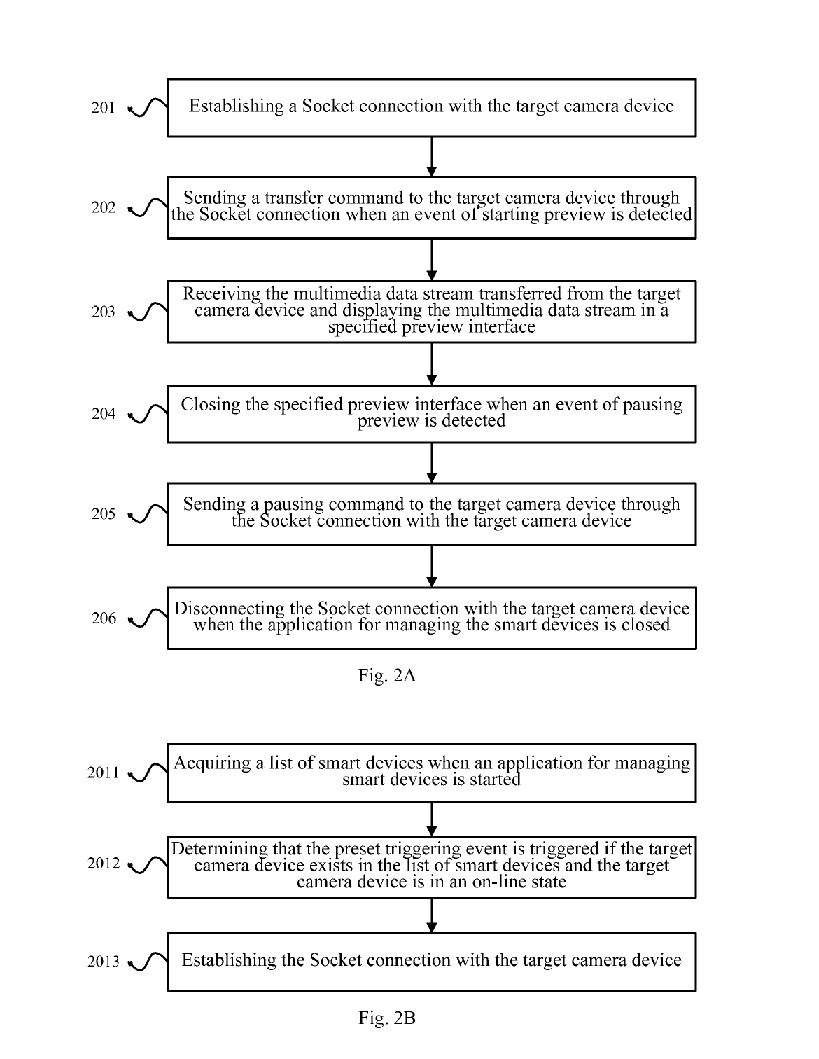

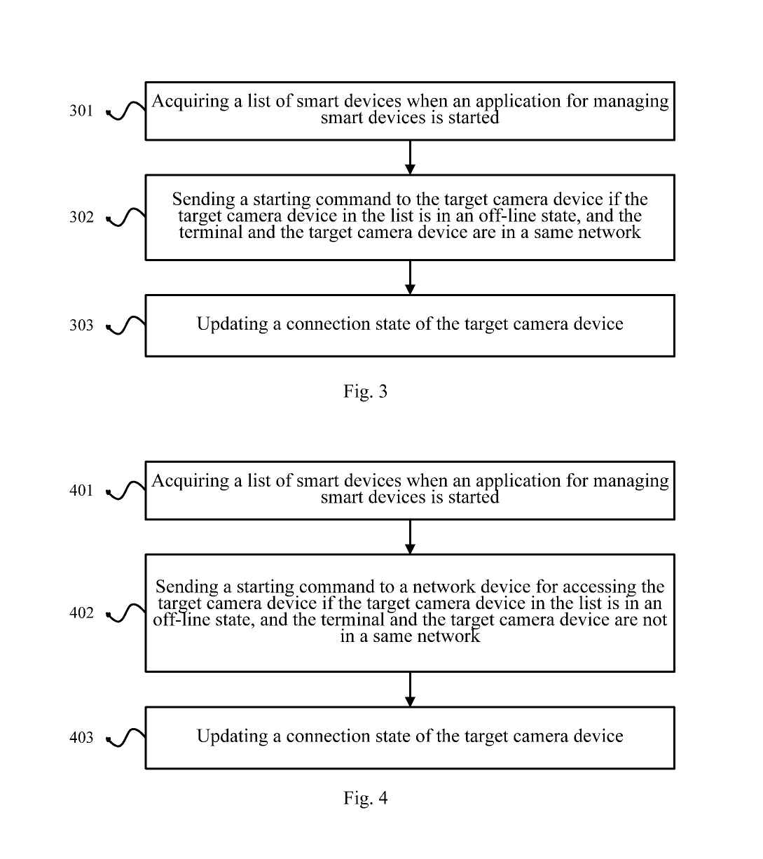

FIG. 2A is a flowchart showing another exemplary method for acquiring a multimedia data stream consistent with the present disclosure. As illustrated in FIG. 2A, at 201, a Socket connection with a target camera device is established when a preset trigger event is triggered. In some embodiments, an application for managing smart devices is started in the terminal, and then a list of smart devices to be managed is acquired and displayed. At this time, it is judged whether there is an associated target device in the list of smart devices. If there is a target camera device, it is further judged whether the target camera device is on-line or off-line. If the target camera device is online, it is determined that the preset triggering event is triggered.

In some embodiments, the list of smart devices includes an identifier, an online time, and a corresponding connection state, of an associated smart device that has been associated with the terminal. In some embodiments, the connection state includes an on-line state and an off-line state. In the list of smart devices, an on-line state of a smart device may be indicated by an identifier displayed in a first color and an off-line state of a smart device may be indicated by an identifier displayed in a second color.

An on-line smart device is a device that is powered on and has an access to the network through a network device. An off-line smart device is a device that is powered off or a device that is powered on but has no access to the network. In some embodiments, the terminal can send a starting command to an off-line smart device to start the smart device and update the connection state of the smart device in the network device or a server from the off-line state to the on-line state.

FIG. 2B shows an example of executing 201 in FIG. 2A. As shown in FIG. 2B, at 2011, a list of smart devices is acquired when an application for managing smart devices is started. At 2012, if there is a target camera device in the list of smart devices and the target camera device is in an on-line state, it is determined that the preset triggering event is triggered. At 2013, the Socket connection with the target camera device is established.

In some embodiments, the process of 2013 includes establishing a background thread and performing the operation of establishing the Socket connection with the target camera device through the background thread. In this process, port numbers for transferring between the terminal and the target camera device are negotiated, such as a port number for an audio stream in the multimedia data stream, a port number for a video stream in the multimedia data stream, and a port number for a controlling command. After that, corresponding contents are transferred respectively according to each of the port numbers upon triggering of a command to transfer the multimedia data stream.

In some embodiments, the terminal and the target camera device with Wi-Fi function are in a same network of a network device. In this scenario, after the target camera device is started, the connection state of the target camera device in the network device is updated to be on-line. After starting the application for managing smart devices, the terminal acquires the connection state of each of the smart devices and updates the list of smart devices in the terminal. At this time, the target camera device in the list of smart devices acquired by the terminal is in an on-line state.

In some embodiments, the terminal and the target camera device with Wi-Fi function are not in a same network of a network device. In this scenario, after the target camera device is started, the connection state of the target camera device is sent to a cloud server through a network device, and the connection state of the target camera device is updated by the cloud server. After starting the application for managing smart devices, the terminal acquires the connection state of each of the smart devices by performing a query with the cloud server and updates the list of smart devices in the terminal. At this time, the target camera device in the list of smart devices acquired by the terminal is in the on-line state. When the terminal and the target camera device are not in a same network, in order to establish the Socket connection, Network Address Translation (NAT) traversal is needed.

In some embodiments, the preset triggering event may include other forms. For example, the preset triggering event can be the terminal being connected in the network.

Referring again to FIG. 2A, at 202, a command to transfer the multimedia data stream to the target camera device through the Socket connection is sent when an event of starting preview is detected. In some embodiments, the event of starting preview is triggered when a user selects to enter the preview interface of the target camera device in the list of smart devices.

At 203, the multimedia data stream transferred from the target camera device is received and is displayed in a specified preview interface. For example, the audio stream, video stream, and controlling command are transferred through the ports negotiated at 2013 shown in FIG. 2B. In some embodiments, a preview interface is established through the application for managing smart devices and the multimedia data stream is displayed in the preview interface.

At 204, the specified preview interface is closed when an event of pausing preview is detected. In some embodiments, the user clicks a quit button in the preview interface when he wants to pause preview of the multimedia data stream. This triggers the event of pausing preview, and the established preview interface is closed.

At 205, a command of pausing transferring the multimedia data stream (hereinafter also referred to as a “pause command”) is sent to the target camera device through the Socket connection with the target camera device. In some embodiments, after the command of pausing transferring the multimedia data stream is sent, the Socket connection with the target camera device is not disconnected, but remains connected. In this manner, before closing the application for managing smart devices, the user can transfer and display the multimedia data stream in real time when the event of starting preview is triggered again in the application for managing smart devices, without re-establishing the Socket connection between the terminal and the target. As such, the user can view the contents from the target camera device without interruption.

That is, after the process of 205 is finished, the processes from 202 to 205 can be performed repeatedly. The process at 206 can be performed when the user wishes to quit from the application for managing smart devices.

At 206, the Socket connection with the target camera device is disconnected when the application for managing smart devices is closed. That is, the Socket connection with the target camera device is not disconnected until the application for managing smart devices is closed.

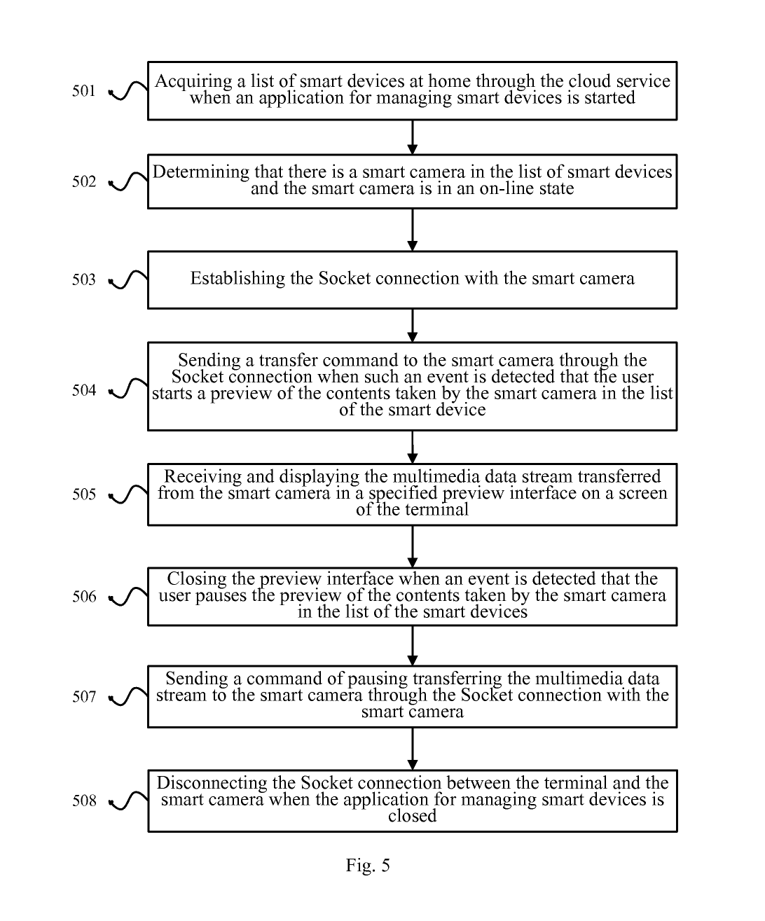

FIG. 3 is a flowchart showing an exemplary method for starting a target camera device through a terminal consistent with the present disclosure. As illustrated in FIG. 3, at 301, a list of smart devices is acquired when an application for managing smart devices is started. In some embodiments, the target camera device in the acquired list of smart devices is in an off-line state.

At 302, if the target camera device in the list of smart devices is in an off-line state, and the terminal and the target camera device are in a same network, a starting command is sent to the target camera device.

In some embodiments, the terminal and the target camera device being in a same network means both the terminal and the target camera device are coupled to a same network device. For example, the user and the corresponding terminal are at home, the target camera device is also at home, and the terminal and the target camera are coupled to a same network device such as a router.

In some embodiments, the starting command may be sent directly to the target camera device from the terminal through the network. Alternatively, the starting command may be received by the network device, and then forwarded to the target camera device by the network device.

When the target camera device, which is in a sleeping state, receives the starting command sent by the terminal, the target camera device starts a waking procedure to enter a normal operation state. The target camera device sends a command for updating state to the network device so that the network device updates the state of the target camera from the off-line state to the on-line state.

At 303, the connection state of the target camera device is updated. That is, since the target camera device in the list of smart devices acquired by the terminal at 301 is in an off-line state, the list of smart devices in the terminal needs to be updated to acquire the new connection state of the target camera. In some embodiments, the terminal sends a request for updating the list of smart devices to the network device, so as to acquire the state of each smart device stored in the network device.

According to the present disclosure, update of the connection state of the target camera device may be triggered by the user manually updating the list of smart devices, or be automatically triggered at a preset time after the starting command is sent out.

According to embodiments of the present disclosure, a starting command is sent to a target camera device that is shown to be in an off-line state, to start the target camera device that is in a sleeping state. A Socket connection between the terminal and the target camera device can then be established.

FIG. 4 is a flowchart showing another exemplary method for starting a target camera device through a terminal consistent with embodiments of the present disclosure. As illustrated in FIG. 4, at 401, a list of smart devices is acquired when an application for managing smart devices is started. In some embodiments, the target camera device in the acquired list of smart devices is in an off-line state.

At 402, if the target camera device in the list of smart devices is in an off-line state, and the target camera device and the terminal are not in a same network, a starting command is sent to a network device for accessing the target camera device after a Socket connection is established by a NAT traversal technique. The network device then forwards the starting command to the target camera device.

When the target camera device that is in a sleeping state receives the starting command, the target camera device starts a waking procedure to enter a normal operation state. The target camera device sends a command for updating state to a cloud server so that the cloud server updates the state of the target camera from the off-line state to the on-line state.

At 403, the connection state of the target camera device is updated. That is, since the target camera device in the list of smart devices acquired by the terminal at 401 is in an off-line state, the list of smart devices in the terminal needs to be updated to acquire the new connection state of the target camera. In some embodiments, the terminal sends a request for updating the list of smart devices to the cloud server, so as to acquire the state of each smart device stored in the cloud server.

According to the present disclosure, update of the connection state of the target camera device may be triggered by the user manually updating the list of smart devices, or be automatically triggered at a preset time after the starting command is sent out.

FIG. 5 is a flowchart showing an exemplary method for acquiring a multimedia data stream consistent with embodiments of the present disclosure. The method shown in FIG. 5 is directed to an example in which the user is at a company and the camera is at home. As illustrated in FIG. 5, at 501, a list of smart devices at home is acquired through a cloud server when an application for managing smart devices is started. In some embodiments, the smart devices at home update their own connection states to the cloud server through a network device at home. The cloud server is configured to record the connection state of each smart device in the list of smart devices associated with the user terminal.

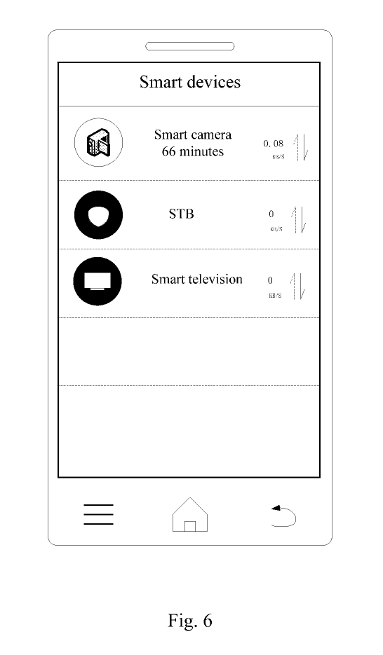

FIG. 6 is a diagram showing an exemplary interface containing the list of smart devices. As illustrated in FIG. 6, currently there are three smart devices associated with the user terminal, i.e., a smart camera, a set-top box (STB), and a smart TV. As illustrated in FIG. 6, an identifier of the smart camera in the list of smart devices is in a light color, which indicates that the smart camera is in an on-line state. The identifiers of the STB and the smart television in the list of smart devices are in a deep color, which indicates that the STB and the smart television are in an off-line state.

Referring again to FIG. 5, at 502, it is determined that there is a smart camera in the list of smart devices and the smart camera is in an on-line state.

At 503, a Socket connection with the smart camera is established. The Socket connection needs to be established by a NAT traversal technique if the terminal and the smart devices are not in a same network.

At 504, a command to transfer a multimedia data stream is sent to the smart camera through the Socket connection when such an event is detected that the user starts a preview of the contents taken by the smart camera in the list of the smart device.

At 505, the multimedia data stream transferred from the smart camera is received and displayed in a specified preview interface on a screen of the terminal.

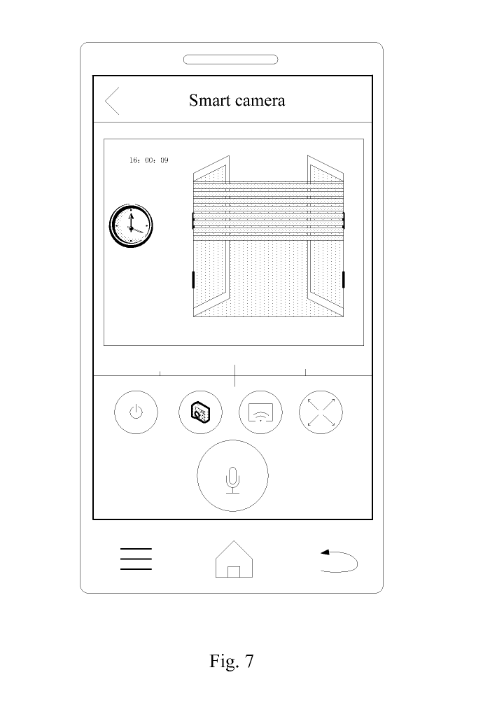

FIG. 7 is a diagram showing an exemplary preview interface. As illustrated in FIG. 7, the preview interface includes a display area for displaying the multimedia data stream transferred from the smart camera, and various control buttons for controlling the smart camera, such as a backward button, a switch button, a capture button, and a full screen button, etc.

Referring again to FIG. 5, at 506, when an event is detected that the user pauses the preview of the contents taken by the smart camera in the list of the smart device, the preview interface is closed. In some embodiments, when the user clicks a backward button in the preview interface of the terminal, the event of pausing preview of the contents taken by the smart camera is triggered, and the preview interface is closed and the interface containing the list of smart devices is displayed.

At 507, the command of pausing transferring the multimedia data stream is sent to the smart camera through the Socket connection with the smart camera.

In some embodiments, before the application for managing smart devices is closed, processes described above at 504-507 can be repeated to preview the contents taken by the smart camera through the pre-established Socket connection between the terminal and the smart camera.

At 508, when the application for managing smart devices is closed, the Socket connection between the terminal and the smart camera is disconnected.

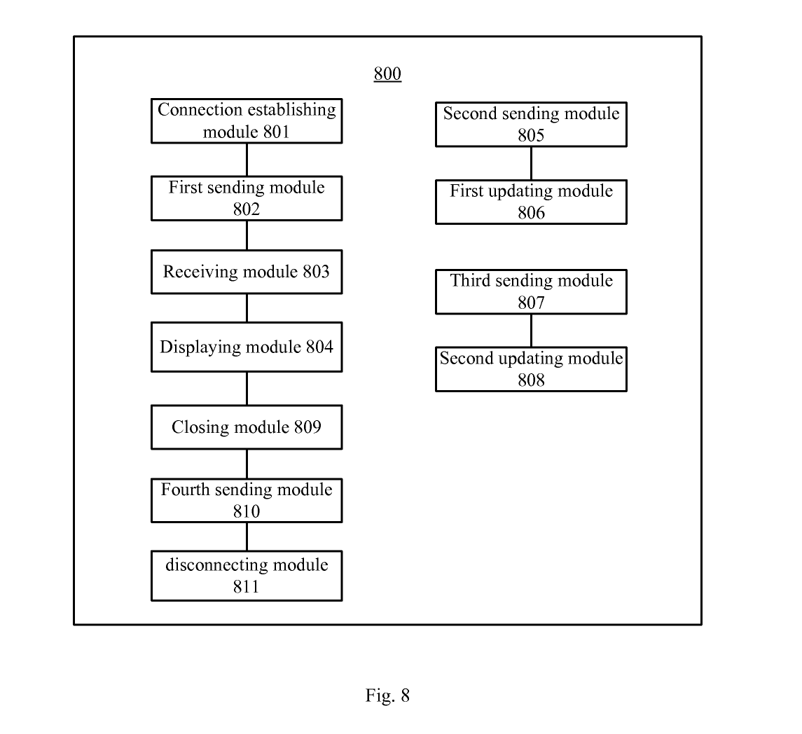

FIG. 8 schematically shows an exemplary device 800 for acquiring a multimedia data stream consistent with embodiments of the present disclosure. As illustrated in FIG. 8, the device 800 includes a connection establishing module 801 configured to establish a Socket connection with a target camera device when a preset triggering event is triggered, a first sending module 802 configured to send a command to transfer the multimedia data stream to the target camera device through the Socket connection when an event of starting preview is detected, a receiving module 803 configured to receive the multimedia data stream transferred from the target camera device, and a displaying module 804 configured to display the multimedia data stream in a specified preview interface.

In some embodiments, the connection establishing module 801 includes an acquiring unit configured to acquire a list of smart devices when an application for managing smart devices is started, a determining unit configured to determine that the preset triggering event is triggered when the target camera device exists in the list of smart devices and the target camera device is in an on-line state, and a connection establishing unit configured to establish the Socket connection with the target camera device.

In some embodiments, as shown in FIG. 8, the device 800 further includes a second sending module 805 and a first updating module 806. The second sending module 805 is configured to send a starting command to the target camera device when the target camera device in the list of smart devices is in an off-line state, and the device 800 and the target camera device are in a same network. The first updating module 806 is configured to update a connection state of the target camera device.

In some embodiments, as shown in FIG. 8, the device 800 further includes a third sending module 807 and a second updating module 808. The third sending module 807 is configured to send a starting command to a network device for accessing the target camera device after the Socket connection is established using a NAT traversal technique, when the target camera device in the list of smart devices is in an off-line state, and the device and the target camera device are not in a same network. The second updating module 808 is configured to update the connection state of the target camera device.

In some embodiments, as shown in FIG. 8, the device 800 further includes a closing module 809 and a fourth sending module 810. The closing module 809 is configured to close the specified preview interface when an event of pausing preview is detected. The fourth sending module 810 is configured to send to the target camera device through the Socket connection with the target camera device a command of pausing transferring the multimedia data stream.

In some embodiments, as shown in FIG. 8, the device 800 further includes a disconnecting module 811, configured to disconnect the Socket connection with the target camera device when the application for managing smart devices is closed.

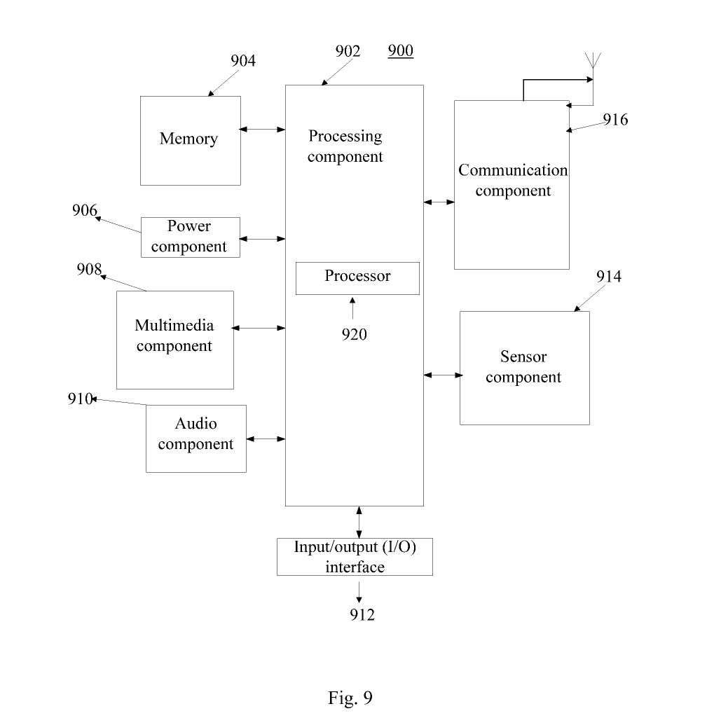

FIG. 9 is a block diagram of an exemplary terminal device 900 for acquiring a multimedia data stream consistent with embodiments of the present disclosure. The device 900 may be a mobile phone, a computer, a digital broadcast terminal, a messaging device, a gaming console, a tablet, a medical device, exercise equipment, a personal digital assistant, or the like.

Referring to FIG. 9, the device 900 includes one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the device 900 and other devices. The device 900 can access a wireless network based on a communication standard, such as WiFi, 2G, 3G, or 4G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 904, executable by the processor 920 in the device 900, for performing one or more of the above-described methods. For example, the non-transitory computer-readable storage medium may be a ROM, a RAM, a CD-ROM, a magnetic tape, a floppy disc, an optical data storage device, or the like.

According to embodiments of the present disclosure, the preview of a multimedia data stream sent by a target camera device can be performed in real time, the efficiency of controlling the target camera device can be improved, and the delay in the preview operation can be reduced.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention only be limited by the appended claims.

What is claimed is:

1. A method for acquiring a multimedia data stream, comprising:
establishing, by a terminal, a socket connection with a target camera device when a preset trigger event is triggered in the terminal;
sending, when an event of starting preview is detected, a transfer command to the target camera device through the socket connection, the transfer command instructing the target camera to transfer the multimedia data stream;
receiving the multimedia data stream transferred by the target camera device; and
displaying the multimedia data stream in a specified preview interface.

2. The method according to claim 1, wherein establishing the socket connection includes:
acquiring a list of smart devices when an application for managing smart devices is started;
determining that the preset triggering event is triggered if the target camera device exists in the list and a connection state of the target camera device is an on-line state; and
establishing the socket connection with the target camera device.

3. The method according to claim 2, further comprising, after acquiring the list:
sending a starting command to the target camera device if:
the connection state of the target camera device in the list is an off-line state, and
the terminal and the target camera device are in a same network; and
updating the connection state of the target camera device.

4. The method according to claim 2, further comprising, after acquiring the list:
sending a starting command to a network device for accessing the target camera device if:
the connection state of the target camera device in the list is an off-line state, and
the terminal and the target camera device are not in a same network; and
updating the connection state of the target camera device.

5. The method according to claim 2, further comprising:
disconnecting the socket connection with the target camera device when the application for managing smart devices is closed.

6. The method according to claim 1, further comprising:
closing the specified preview interface when an event of pausing preview is detected; and
sending a pause command to the target camera device through the socket connection with the target camera device, the pause command instructing the target camera device to pause transferring the multimedia data stream.

7. The method according to claim 1, further comprising:
disconnecting the socket connection with the target camera device when the application for managing smart devices is closed.

8. A device for acquiring a multimedia data stream, comprising:
a processor; and
a non-transitory computer-readable storage medium storing instructions that, when executed by the processor, cause the processor to:
establish a socket connection with a target camera device when a preset trigger event is triggered;
send, when an event of starting preview is detected, a transfer command to the target camera device through the socket connection, the transfer command instructing the target camera to transfer the multimedia data stream;
receive the multimedia data stream transferred by the target camera device; and
display the multimedia data stream in a specified preview interface.

9. The device according to claim 8, wherein the instructions further cause the processor to:
acquire a list of smart devices when an application for managing smart devices is started;
determine that the preset triggering event is triggered if the target camera device exists in the list and a connection state of the target camera device is an on-line state; and
establish the socket connection with the target camera device.

10. The device according to claim 9, wherein the instructions further cause the processor to:
send a starting command to the target camera device if:
the connection state of the target camera device in the list is an off-line state, and
the terminal and the target camera device are in a same network; and
update the connection state of the target camera device.

11. The device according to claim 9, wherein the instructions further cause the processor to:
send a starting command to a network device for accessing the target camera device if:
the connection state of the target camera device in the list is an off-line state, and
the terminal and the target camera device are not in a same network; and
update the connection state of the target camera device.

12. The device according to claim 9, wherein the instructions further cause the processor to:
disconnect the socket connection with the target camera device when the application for managing smart devices is closed.

13. The device according to claim 8, wherein the instructions further cause the processor to:
close the specified preview interface when an event of pausing preview is detected; and
send a pause command to the target camera device through the socket connection with the target camera device, the pause command instructing the target camera device to pause transferring the multimedia data stream.

14. The device according to claim 8, wherein the instructions further cause the processor to:
disconnect the socket connection with the target camera device when the application for managing smart devices is closed.

15. A non-transitory computer-readable storage medium storing instructions that, when executed by a processor of a terminal, cause the terminal to:
establish a socket connection with a target camera device when a preset trigger event is triggered;
send, when an event of starting preview is detected, a transfer command to the target camera device through the socket connection, the transfer command instructing the target camera to transfer a multimedia data stream;
receive the multimedia data stream transferred by the target camera device; and
display the multimedia data stream in a specified preview interface.

16. The storage medium according to claim 15, wherein the instructions further cause the terminal to:
acquire a list of smart devices when an application for managing smart devices is started;
determine that the preset triggering event is triggered if the target camera device exists in the list and a connection state of the target camera device is an on-line state; and
establish the socket connection with the target camera device.

17. The storage medium according to claim 16, wherein the instructions further cause the terminal to:
send a starting command to the target camera device if:
the connection state of the target camera device in the list is an off-line state, and
the terminal and the target camera device are in a same network; and
update the connection state of the target camera device.

18. The storage medium according to claim 16, wherein the instructions further cause the terminal to:
send a starting command to a network device for accessing the target camera device if:
the connection state of the target camera device in the list is an off-line state, and
the terminal and the target camera device are not in a same network; and
update the connection state of the target camera device.

19. The storage medium according to claim 15, wherein the instructions further cause the terminal to:
close the specified preview interface when an event of pausing preview is detected; and
send a pause command to the target camera device through the socket connection with the target camera device, the pause command instructing the target camera device to pause transferring the multimedia data stream.

20. The storage medium according to claim 15, wherein the instructions further cause the terminal to:
disconnect the socket connection with the target camera device when the application for managing smart devices is closed.
